(19) United States
(12) Patent Application Publication
(10) Pub. No.: US 2021/0378912 A1
(43) Pub. Date: Dec. 9, 2021

(54) ACUPUNCTURE NEEDLE AND METHOD OF FORMING ACUPUNCTURE NEEDLE

(71) Applicant: SEIRIN CORPORATION, Shizuoka-shi (JP)

(72) Inventors: Ryoichi NAKANO, Shizuoka (JP); Yuya KANEKO, Shizuoka (JP); Shohei TANIGUCHI, Shizuoka (JP); Takuya KOBAYASHI, Shizuoka (JP)

(21) Appl. No.: 17/114,495

(22) Filed: Dec. 8, 2020

(30) Foreign Application Priority Data
Jun. 3, 2020 (JP) 2020-96918
Sep. 29, 2020 (JP) 2020-163126

(51) Int. Cl. A61H 39/08

(52) U.S. Cl. CPC A61H 39/086

(57) ABSTRACT

A method of forming an acupuncture needle includes forming an acupuncture needle having a needle body having a needle tip portion at a leading end thereof, and a needle grip attached to a base end portion of the needle body. A cross-sectional shape crossing a longitudinal direction of the acupuncture needle at a middle of the needle grip in the longitudinal direction is an ellipse. A groove portion is provided along an outer circumference of the needle grip. When using as an acupuncture needle with a long needle grip, the needle grip is maintained without being separated at the groove portion. When using as an acupuncture needle with a short needle grip, the needle grip is bent with a bending load direction in a minor axis direction of the ellipse to separate the needle grip at the groove portion.

### RELATED APPLICATION

The present application claims priority to Japanese Application Number 2020-096918 filed Jun. 3, 2020 and Japanese Application Number 2020-163126 filed Sep. 29, 2020, the disclosures of which are hereby incorporated by reference herein in their entireties.

### TECHNICAL FIELD

The instant application relates to an acupuncture needle and a method of forming an acupuncture needle, and in particular to an acupuncture needle having good usability and a method of forming an acupuncture needle.

### BACKGROUND TECHNOLOGY

There are acupuncture needles having a needle body having a needle tip portion formed at a leading end thereof and a needle grip attached to a base end portion of the needle body (Patent Literature 1).

This acupuncture needle does not have any problem when inserted into a body so as to be orthogonal to the body to apply stimulation to relieve pain and relieve stiff shoulders and back pain.

On the other hand, apart from the above-mentioned acupuncture needle, there is an intradermal needle which is an acupuncture needle inserted into the skin horizontally with respect to the skin (Patent Literature 2).

The intradermal needle in Patent Literature 2 is special, which includes a grip and a needle body, an extension portion integrally formed on the grip, and a notch provided at a boundary between the grip and the extension portion, and made to be separated at the notch and remove the extension portion. The intradermal needle described in Patent Literature 2 is considered only for the use as an intradermal needle, thus, as an acupuncture needle for normal acupuncture, if the extension portion remains as is, the strength cannot be maintained, and is not suitable for use.

### PRIOR ART REFERENCES

### Patent Literature

[Patent Literature 1] Japanese Patent Publication No. 2019-136385

[Patent Literature 2] Japanese Utility Model Publication No. S51-2473

### SUMMARY

### Problems to be Solved

An intradermal needle that is inserted into the skin horizontally with respect to the skin, separately from the above-mentioned acupuncture needle.

Even if the above-mentioned acupuncture needle is used as an intradermal needle that is inserted into the skin horizontally with respect to the skin, the needle grip is heavy, thus, the intradermal needle inserted into the skin may come out due to its own weight, causing pain and inflammation to the patient, thereby, not suitable for use.

The present application provides an acupuncture needle and a method for forming an acupuncture needle in consideration of the above-mentioned problems.

### Effect

According to the method for forming an acupuncture needle according to at least one embodiment, because an ellipse has more strength against a load in a major axis direction than a load in a minor axis direction, a needle grip having a cross-sectional shape being the ellipse maintains the strength of a commonly used acupuncture needle having a long needle grip. Moreover, by bending the needle grip with a bending load direction in the minor axis direction of the cross-sectional shape being the ellipse, the needle grip is easily separated at the groove portion to form the acupuncture needle having the needle grip shorter in length in a longitudinal direction than the needle grip before being separated.

That is, one acupuncture needle commonly used and an acupuncture needle with a short needle grip can be easily formed depending on whether or not the needle grip is separated at the groove portion.

Further, according to the method for forming an acupuncture needle according to at least one embodiment, because an ellipse has more strength against a load in a major axis direction than a load in a minor axis direction, a needle grip having a cross-sectional shape being the ellipse maintains the strength of a commonly used acupuncture needle having a long needle grip. Moreover, because a groove portion is provided on an outer periphery of the needle grip along the major axis direction of the ellipse, the groove portion is used as a fulcrum for bending. That is, by bending the needle grip with a bending load direction in the minor axis direction of the cross-sectional shape being the ellipse, the needle grip is easily separated at the groove portion to form the acupuncture needle having the needle grip shorter in length in the longitudinal direction than the needle grip before being separated.

That is, one acupuncture needle commonly used and an acupuncture needle with a short needle grip can be easily formed depending on whether or not the needle grip is separated at the groove portion.

Further, according to the method for forming an acupuncture needle according to at least one embodiment, because the needle grip has more strength against a load in an H direction than a load in an h direction, the strength of a commonly used acupuncture needle having a long needle grip is maintained. Moreover, because an outer peripheral edge AB and/or an outer peripheral edge CD is provided with a valley portion of the groove portion, the valley portion of the groove portion is used as a fulcrum for bending. That is, by bending the needle grip with a bending load direction in the H direction, the needle grip is separated at the valley portion of the groove portion to form an acupuncture needle having the needle grip shorter in length in a longitudinal direction than the needle grip before being separated.

That is, one acupuncture needle commonly used and an acupuncture needle with a short needle grip can be easily formed depending on whether or not the needle grip is separated at the valley portion of the groove portion.

Further, according to the method for forming an acupuncture needle according to at least one embodiment, in addition to the effects described above, by bending the second needle grip toward the first needle grip and causing a first inclined surface and a second inclined surface to contact with each other, a separation does not occur, unless an additional force is applied to bend beyond an outermost portion of the first inclined surface and an outermost of the second inclined surface to cause a first end portion and a second end portion to contact with each other, and use a contacting portion as a fulcrum for breaking the acupuncture needle at the groove portion by the principle of leverage to separate the needle grip into the first needle grip and the second needle grip.

In other words, when separating, the separation is performed with the consciousness of separation and an inadvertent separation can be prevented. The first end portion and the second end portion may not necessarily be a tapered portion, but may be corners or R surfaces.

Further, the acupuncture needle according to at least one embodiment has more strength against bending in a minor axis direction of the ellipse than a bending in a major axis direction of the ellipse, and maintains the strength of a commonly used acupuncture needle with a long needle grip. Moreover, because the groove portion is provided along the major axis direction of the ellipse, by bending along the major axis direction of the ellipse, a separation occurs with ease and an acupuncture needle with a short needle grip is obtained. That is, by employing an acupuncture needle with a short needle grip from one commonly used acupuncture needle, an intradermal acupuncture needle can be easily formed.

Further, the acupuncture needle according to at least one embodiment has more strength against bending in a maximum distance H (H>h) direction than bending in a maximum distance h direction, and maintains the strength of a commonly used acupuncture needle having a long needle grip. Moreover, because a periphery AB and/or a periphery CD is provided with an easy separation portion, by bending along a direction of the maximum distance h, a separation occurs with ease and an acupuncture needle with a short needle grip is obtained. That is, from one commonly used acupuncture needle, an acupuncture needle with a short needle grip can be easily formed.

Further, according to the acupuncture needle according to at least one embodiment, in addition to the effect described above, by bending the second needle grip toward the first needle grip and causing a first inclined surface and a second inclined surface to contact with each other, a separation does not occur, unless an additional force is applied to exceed beyond an outermost portion of a first inclined surface and an outermost of the second inclined surface to cause a first end portion and a second end portion to contact with each other, and break the needle grip at the groove portion to separate the needle grip into the first needle grip and the second needle grip. That is, when separating, the separation is performed with the consciousness of separation and an inadvertent separation can be prevented.

### BRIEF DESCRIPTION OF THE DRAWINGS

FIG. 1A is a schematic view of an acupuncture needle according to at least one embodiment of the present application, FIG. 1B is a schematic view showing a state in which the needle grip in FIG. 1A is bent at a middle thereof, and FIG. 1C is a schematic view showing a state in which the middle of the needle grip in FIG. 1B is further bent.

FIG. 2 is a schematic enlarged view of E in FIG. 1A.

FIG. 3 is a schematic enlarged view of F in FIG. 1B.

FIG. 4 is a schematic enlarged view of G in FIG. 1C.

FIG. 5 is a schematic view of an acupuncture needle in FIG. 1A cut at the needle grip.

FIG. 6 is a schematic cross-sectional view taken along the line 5-5 in FIG. 5.

FIG. 7A is a schematic perspective view of an acupuncture needle of at least one embodiment different from the acupuncture needle in FIGS. 1A-1C, FIG. 7B is a schematic plan view of FIG. 7A, FIG. 7C is a schematic cross-sectional view taken along the line 7-7 in FIG. 7B, FIG. 7D is a schematic cross-sectional view taken along the line 7′-7′ in FIG. 7B, FIG. 7E is a schematic front view of FIG. 7B, FIG. 7F is a schematic left side view of FIG. 7E, and FIG. 7G is a schematic right side view of FIG. 7E.

FIG. 8A is a schematic perspective view of an acupuncture needle of at least one embodiment different from the acupuncture needle in FIGS. 7A-7G, FIG. 8B is a schematic plan view of FIG. 8A, FIG. 8C is a schematic front view of FIG. 8B, FIG. 8D is a schematic left side view of FIG. 8C, FIG. 8E is a schematic right side view of FIG. 8C, FIG. 8F is a schematic cross-sectional view taken along the line 8-8 in FIG. 8C (a schematic cross-sectional view of a valley portion of a groove portion crossing a longitudinal direction of a needle grip of the acupuncture needle), and FIG. 8G is a schematic cross-sectional view taken along the line 8′-8′ in FIG. 8C (a cross-sectional view of a ridge portion of the groove portion crossing the longitudinal direction of the needle grip of the acupuncture needle).

### DETAILED DESCRIPTION

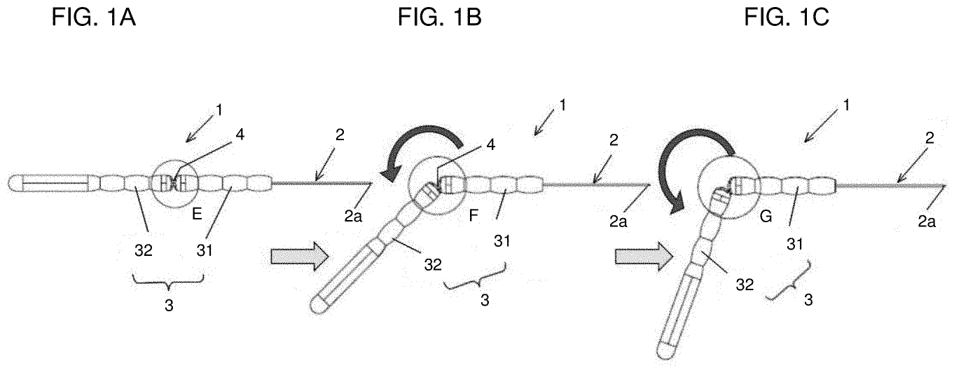

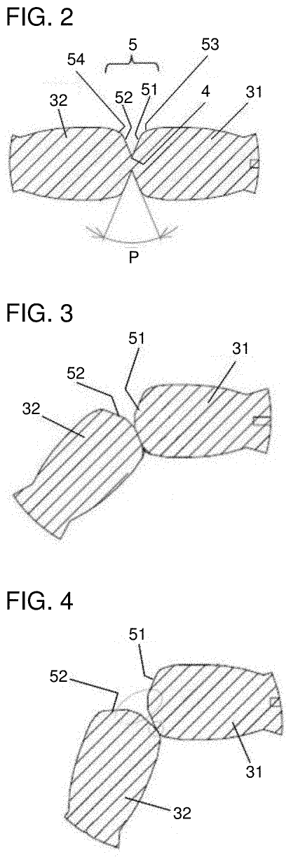

The acupuncture needle and the method of forming the acupuncture needle according to at least one embodiment of the present application will be described with reference to FIGS. 1A-5. Reference 1 shown in FIGS. 1A-1C refers to an acupuncture needle, and the acupuncture needle 1 includes a needle body 2 having a needle tip portion 2a formed at a leading end thereof and a needle grip 3 attached to a base end portion of the needle body 2. The needle body 2 is a linear body including metal such as stainless steel, and the needle tip portion 2a is formed at the leading end thereof. The needle body 2 has a thickness and a length suitable for therapeutic purposes, manual procedures, and the like. A thickness (wall thickness) of the needle body 2 is, for example, 0.10 mm to 0.35 mm, and the length is, for example, 15 mm to 150 mm. The needle grip 3 includes plastic or metal such as stainless steel, and in at least one embodiment, plastic is used.

Further, an easy separation portion (specifically, the easy separation portion is a groove portion portion) 4 is provided in a direction crossing a longitudinal direction of the needle grip 3 of the acupuncture needle 1 at a middle of the needle grip 3 of the acupuncture needle 1 in the longitudinal direction. Further, a cross section crossing the longitudinal direction of the needle grip 3 of the acupuncture needle 1 at the middle of the needle grip 3 of the acupuncture needle 1 in the longitudinal direction is an ellipse (see FIG. 6), and a groove portion 4 is provided along a major axis direction of the ellipse.

Since the groove portion 4 has a structure so that when bent at the groove portion 4 with the hand over a predetermined angle, the needle grip 3 is separated, an acupuncture needle 1 having a needle grip 3 shorter in length in the longitudinal direction than the needle grip 3 before being separated by hand is formed. When using as an acupuncture needle having a long needle grip, the needle grip is not separated at the groove portion 4 and maintained as is [the acupuncture needle 1 as shown in FIG. 1A]. When using as an acupuncture needle with a short needle grip, the needle grip is bent with a bending load direction in a minor axis direction of the cross-sectional shape being the ellipse and separated at the groove portion to form the acupuncture needle having the needle grip shorter in length in the longitudinal direction than the needle grip before being separated.

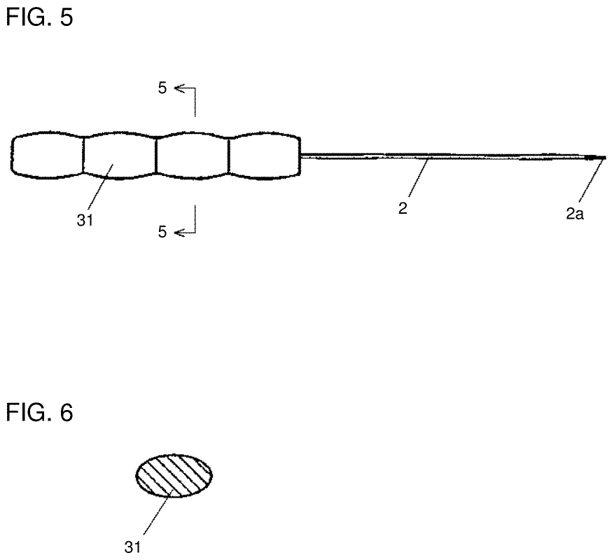

According to the above-mentioned method of forming acupuncture needle (the acupuncture needle 1), since the ellipse has more strength against the load in the major axis direction than the load in the minor axis direction, the needle grip 3 having a cross-sectional shape being the ellipse maintains the strength of a commonly used acupuncture needle having a long needle grip [the acupuncture needle 1 shown in FIG. 1A]. In addition, by bending the needle grip with the bending load direction in the minor axis direction of the cross-sectional shape being the ellipse, the needle grip is easily separated at the groove portion to form the acupuncture needle having the needle grip shorter in length in the longitudinal direction [the acupuncture needle 1 shown in FIG. 5] than the needle grip before being separated.

That is, one acupuncture needle commonly used and an acupuncture needle with the short needle grip can be easily formed depending on whether or not the needle grip is separated at the groove portion 4.

In this way, one acupuncture needle 1 can be adapted to the usage of the practitioner. The acupuncture needle 1 with the short needle grip 3 can be used as, for example, an intradermal needle.

The needle grip 3 has a first needle grip 31 and a second needle grip 32 with the groove portion 4 therebetween. The needle body 2, the first needle grip 31, the groove portion 4, and the second needle grip 32 are positioned in this order in the longitudinal direction of the acupuncture needle 1. The groove portion 4 is a thin-walled connecting portion provided at the middle of the needle grip 3 in the longitudinal direction, and by breaking the needle grip at the groove portion 4 being the thin-walled connecting portion, the needle grip 3 is separated into the first needle grip 31 and the second needle grip 32. Alternatively, in at least one embodiment, the groove portion 4 includes a first tapered portion 5 (an angle degree P is, for example, 45°) at a central portion crossing the longitudinal direction of the needle grip 3 and extending outwardly from the central portion and end portions facing outwardly from the first tapered portion 5. The first tapered portion 5 includes a first inclined surface 51 and a second inclined surface 52. The end portions include a first end portion 53 and a second end portion 54.

As shown in FIG. 1B, the second needle grip 32 is bent toward the first needle grip 31, and when the angle formed by the first inclined surface 51 and the second inclined surface 52 is less than 45°, the first inclined surfaces 51 and 52 do not interfere with each other.

When the second needle grip 32 is bent further and the angle formed by the first inclined surface 51 and the second inclined surface 52 exceeds 45°, the first inclined surface 51 and the second inclined surface 52 contact each other, and as shown in FIG. 1C, the first end portion 53 and the second end portion 54 exceed outermost portions of the first inclined surface 51 and the second inclined surface 52 to contact each other, and the needle grip is broken at the groove portion 4, and the needle grip 3 is separated into the first needle grip 31 and the second needle grip 32 (see FIGS. 4 and 5).

The groove portion 4 is not limited to the thin-walled connecting portion provided at the middle of the needle grip 3 shown in FIG. 2 in the longitudinal direction, and may be formed as the thin-walled connecting portion not provided with a tapered portion extending outwardly from the central portion as shown in FIG. 2, and although not shown, may be formed so that the first inclined surface 51 and the second inclined surface 52 are parallel to each other.

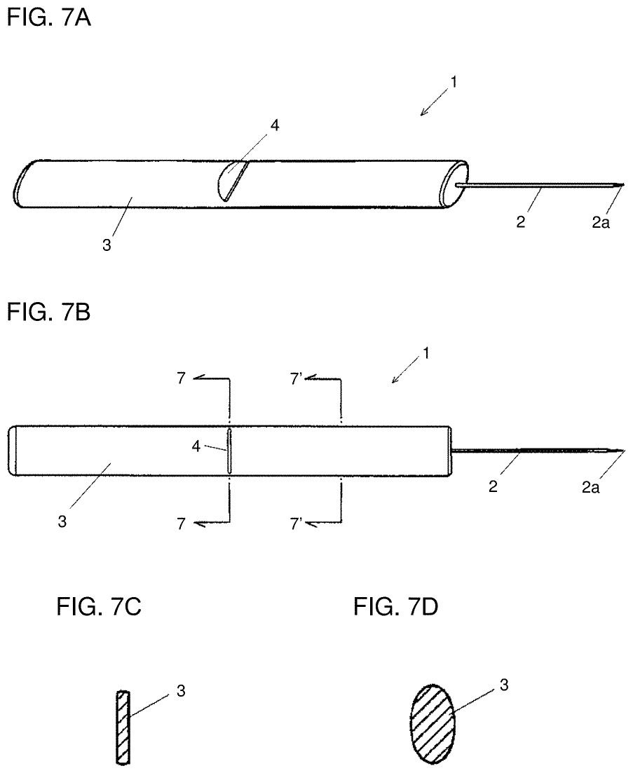

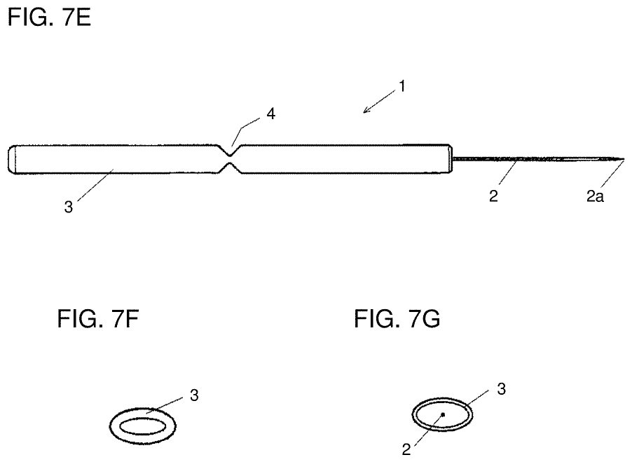

According to the above-described at least one embodiment, the groove portion 4 is provided along the outer periphery of the needle grip 3 (the groove portion 4, for example, is provided along the entire outer periphery of the needle grip 3), but the description is not limited to this, for example, as shown in FIGS. 7A-7G, the groove portion 4 can be provided along the major axis direction of the ellipse (the groove portion 4, for example, is provided along the major axis direction of the ellipse, and not provided along the minor axis direction of the ellipse).

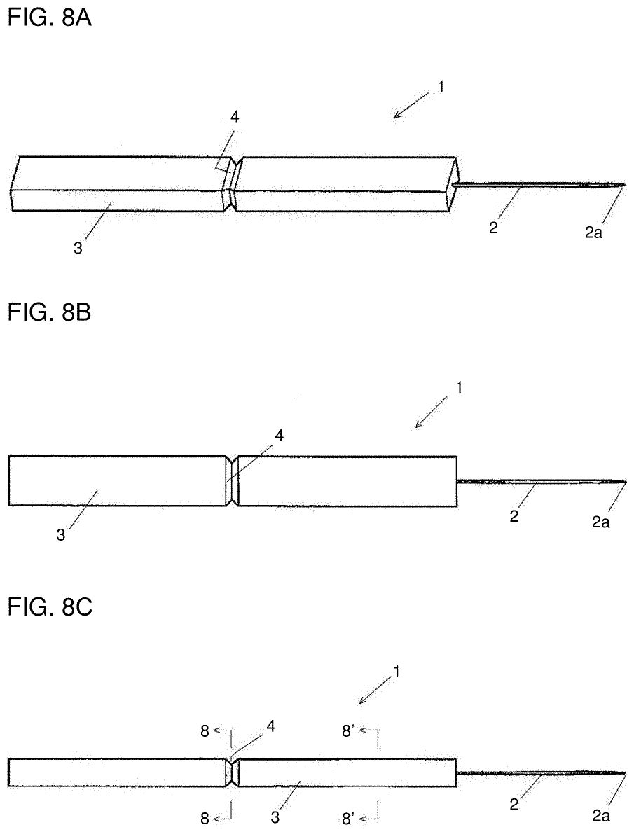

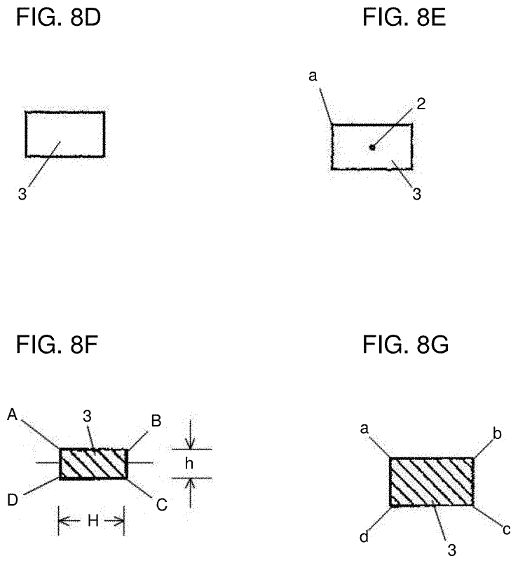

Further, according to the above-described at least one embodiment, the cross section of the acupuncture needle 1 crossing the longitudinal direction of the needle grip 3 is an ellipse (see FIG. 6), but the description is not limited to this, for example, the cross section crossing the longitudinal direction of the needle grip 3 of the acupuncture needle 1 may be as shown in FIGS. 8A to 8G.

That is, the acupuncture needle, like the acupuncture needle 1 described above, has a needle body 2 having a needle tip portion formed at the leading end thereof and a needle grip 3 attached to the base end portion of the needle body 2.

FIG. 8F shows ABCD being a shape of a cross section, crossing the longitudinal direction of the needle grip 3 of the acupuncture needle 1, of the groove portion 4 at a valley portion. FIG. 8G shows abcd being a shape of a cross section, crossing the longitudinal direction of the needle grip 3 of the acupuncture needle 1, of the groove portion 4 at a ridge portion.

Then, an outer peripheral edge of a cross section crossing a longitudinal direction of the needle grip 3 of the acupuncture needle at a middle of the needle grip 3 of the acupuncture needle in the longitudinal direction is ABCDA in clockwise, and A and B are opposite to D and C with respect to a neutral axis X of the cross section, respectively.

A maximum distance h is among a distance between an outer peripheral edge AB and an outer peripheral edge CD opposite to each other, and a maximum distance H (H>h) is among a distance between an outer peripheral edge AD and an outer peripheral edge BC opposite to each other. A valley portion of the groove portion is provided at the outer peripheral edge AB and/or at the outer peripheral edge CD. When using as an acupuncture needle 1 having a long needle grip, the needle grip is maintained without being separated at the valley portion of the groove portion 4. When using as an acupuncture needle 1 having a short needle grip, the needle grip is bent using the valley portion of the groove portion 4 as a fulcrum (bending with a bending load direction in a direction along the h) to separate at the valley portion of the groove portion 4, and form the acupuncture needle having the needle grip 3 shorter in length in the longitudinal direction than the needle grip 3 before being separated.

According to the acupuncture needle 1 (a method of forming an acupuncture needle), because the needle grip 3 has more strength against a load in the H direction than a load in the h direction, and a strength of a commonly used acupuncture needle having a long needle grip is maintained. In addition, because an outer peripheral edge AB and/or an outer peripheral edge CD is provided with a valley portion of the groove portion 4, the valley portion of the groove portion 4 is used as a fulcrum for bending. That is, by bending the needle grip with a bending load direction in the H direction, the needle grip is separated at the valley portion of the groove portion 4 to form an acupuncture needle having the needle grip 3 shorter in length in a longitudinal direction than the needle grip 3 before being separated.

That is, one acupuncture needle 1 commonly used and an acupuncture needle 1 having a short needle grip can be easily formed depending on whether or not the needle grip is separated at the valley portion of the groove portion 4.

The shape of ABCDA in which the outer peripheral edge of the cross-section crossing the longitudinal direction of the needle grip 3 is formed clockwise is not limited to the rectangle shown in FIGS. 8A-8G, and may be a rectangle with corners rounded with R or an ellipse.

What is claimed is:

1. A method of forming an acupuncture needle, comprising:
forming the acupuncture needle including a needle body having a needle tip portion formed at a leading end thereof and a needle grip attached to a base end portion of the needle body, wherein a cross-sectional shape crossing a longitudinal direction of the needle grip of the acupuncture needle at a middle of the needle grip of the acupuncture needle in the longitudinal direction is an ellipse,
a groove portion is provided along an outer circumference of the needle grip,
when using as an acupuncture needle with a long needle grip, the needle grip is maintained without being separated at the groove portion, and
when using as an acupuncture needle with a short needle grip, the needle grip is bent with a bending load direction in a minor axis direction of the cross-sectional shape being the ellipse to separate the needle grip at the groove portion, and form the acupuncture needle having the needle grip shorter in length in the longitudinal direction than the needle grip before being separated.

2. A method of forming an acupuncture needle, comprising:
forming the acupuncture needle including a needle body having a needle tip portion formed at a leading end thereof and a needle grip attached to a base end portion of the needle body, wherein
a cross-sectional shape crossing a longitudinal direction of the needle grip of the acupuncture needle at a middle of the needle grip of the acupuncture needle in the longitudinal direction is an ellipse,
a groove portion is provided along an outer periphery of the needle grip along a major axis direction of the ellipse,
when using as an acupuncture needle with a long needle grip, the needle grip is maintained without being separated at the groove portion, and
when using as an acupuncture needle with a short needle grip, the needle grip is bent with a bending load direction in a minor axis direction of the cross-sectional shape being the ellipse to separate the needle grip at the groove portion, and form the acupuncture needle having the needle grip shorter in length in the longitudinal direction than the needle grip before being separated.

3. A method of forming an acupuncture needle, comprising:
forming the acupuncture needle including a needle body having a needle tip portion formed at a leading end, and a needle grip attached to a base end portion of the needle body, wherein
an outer peripheral edge of a cross section crossing a longitudinal direction of the needle grip of the acupuncture needle at a middle of the needle grip of the acupuncture needle in the longitudinal direction is ABCDA in clockwise, A and B being opposite to D and C with respect to a neutral axis of the cross section, respectively,
a maximum distance h is among a distance between an outer peripheral edge AB and an outer peripheral edge CD opposite to each other, and a maximum distance H (H>h) is among a distance between an outer peripheral edge AD and an outer peripheral edge BC opposite to each other,
a valley portion of a groove portion is provided at the outer peripheral edge AB and/or at the outer peripheral edge CD,
when using as an acupuncture needle with a long needle grip, the needle grip is maintained without being separated at the valley portion of the groove portion, and
when using as an acupuncture needle with a short needle grip, the needle grip is bend using the valley portion of the groove portion as a fulcrum (bending with a bending load direction in a direction along the h) to separate at the valley portion of the groove portion, and form the acupuncture needle having the needle grip shorter in length in the longitudinal direction than the needle grip before being separated.

4. The method of forming the acupuncture needle according to claim 1, wherein
the needle grip has a first needle grip and a second needle grip with the groove portion therebetween,
a positional relationship in the longitudinal direction of the acupuncture needle is in the order of the needle body, the first needle grip, the groove portion, and the second needle grip,
the groove portion is at a central portion crossing the longitudinal direction of the needle grip, and has a first tapered portion extending outwardly from the central portion, and end portions facing outwardly from the first tapered portion,
the first tapered portion includes a first inclined surface and a second inclined surface,
the end portions include a first end portion and a second end portion, and
the second needle grip is bent toward the first needle grip to cause the first inclined surface and the second inclined surface to contact with each other, and further bent beyond an outermost portion of the first inclined surface and an outermost portion of the second inclined surface to cause the first end portion and the second end portion to contact with each other to break the needle grip at the groove portion, and separate the needle grip into the first needle grip and the second needle grip.

5. An acupuncture needle comprising:
a needle body having a needle tip portion formed at a leading end thereof; and
a needle grip attached to a base end portion of the needle body, wherein
a cross section crossing a longitudinal direction of the needle grip of the acupuncture needle at a middle of the needle grip of the acupuncture needle in the longitudinal direction is an ellipse, and
a groove portion is provided along an outer circumference of the ellipse or a major axis direction of the ellipse.

6. An acupuncture needle comprising:
a needle body having a needle tip portion formed at a leading end thereof; and
a needle grip attached to a base end portion of the needle body, wherein
an outer peripheral edge of a cross-section crossing a longitudinal direction of the needle grip of the acupuncture needle at a middle of the needle grip of the acupuncture needle in the longitudinal direction is ABCDA in clockwise, A and B being opposite to D and C with respect to a neutral axis of the cross-section, respectively,
a maximum distance h is among a distance between an outer peripheral edge AB opposite to each other and an outer peripheral edge CD opposite to each other, and a maximum distance H (H>h) is among a distance between an outer peripheral edge AD and an outer peripheral edge BC opposite to each other, and
a groove portion is provided at the outer peripheral edge AB and/or at the outer peripheral edge CD.

7. The acupuncture needle according to claim 5, wherein
the needle grip has a first needle grip and a second needle grip with the groove portion therebetween,
a positional relationship in the longitudinal direction of the acupuncture needle is in the order of the needle body, the first needle grip, the groove portion, and the second needle grip,
the groove portion is at a central portion crossing the longitudinal direction of the needle grip, and has a first tapered portion extending outwardly from the central portion, and end portions facing outwardly from the first tapered portion,
the first tapered portion includes a first inclined surface and a second inclined surface,
the end portions include a first end portion and a second end portion, and
the second needle grip is bent toward the first needle grip to cause the first inclined surface and the second inclined surface to contact with each other, and further bent beyond an outermost portion of the first inclined surface and an outermost portion of the second inclined surface to cause the first end portion and the second end portion to contact with each other to break the needle grip at the groove portion, and separate the needle grip into the first needle grip and the second needle grip.
